(19) United States
(12) Patent Application Publication
(10) Pub. No.: US 2024/0310545 A1
(43) Pub. Date: Sep. 19, 2024

(54) SYSTEMS AND METHODS FOR EFFICIENTLY PERFORMING STOCHASTIC INVERSION METHODS IN SEISMIC EXPLORATION APPLICATIONS

(71) Applicant: BP Corporation North America Inc., Houston, TX (US)

(72) Inventors: Madhav Vyas, Houston, TX (US); Esteban Diaz Pantin, Houston, TX (US)

(73) Assignee: BP Corporation North America Inc., Houston, TX (US)

(21) Appl. No.: 18/604,308

(22) Filed: Mar. 13, 2024

Related U.S. Application Data
(60) Provisional application No. 63/452,092, filed on Mar. 14, 2023.

(51) Int. Cl. G01V 1/34; G01V 1/30; G06T 7/10; G06T 9/00

(52) U.S. Cl. CPC G01V 1/345; G01V 1/306; G06T 7/10; G06T 9/00; G01V 2210/66

(57) ABSTRACT

A method includes generating an initial subsurface model having an initial dimensionality and based at least in part on initial seismic data, compressing the initial model subsurface model to reduce a dimensionality of the initial subsurface model and form a compressed subsurface model having a compressed dimensionality that is less than the initial dimensionality, producing an initial plurality of particles from the compressed subsurface model at the compressed dimensionality, selecting particles from the initial plurality of particles, expanding the selected particles to return the selected particles to the initial dimensionality, iteratively updating a value of each particle of the selected particles utilizing synthetic seismic data produced from the initial subsurface model to generate a posterior set of particles, and outputting the posterior set of particles as a target distribution.

### CROSS-REFERENCE TO RELATED APPLICATIONS

This application claims benefit of U.S. provisional patent application Ser. No. 63/452,092 filed Mar. 14, 2023, and entitled “Method and Apparatus for Performing Stein-Variational Gradient Descent for Computationally-Expensive Problems,” which is hereby incorporated herein by reference in its entirety for all purposes.

### STATEMENT REGARDING FEDERALLY SPONSORED RESEARCH OR DEVELOPMENT

Not applicable.

### BACKGROUND

The present disclosure relates generally to analyzing seismic data, and more specifically, to performing Stein-Variational Gradient Descent (SVGD) for computationally-expensive problems.

This section is intended to introduce the reader to various aspects of art that may be related to various aspects of the present disclosure, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

A seismic survey includes generating an image or map of a subsurface region of the Earth by sending sound energy down into the ground and recording the reflected sound energy that returns from the geological layers within the subsurface region. During a seismic survey, an energy source is placed at various locations on or above the surface region of the Earth, which may include hydrocarbon deposits. Each time the source is activated, the source generates a seismic (e.g., sound wave) signal that travels downward through the Earth, is reflected, and, upon its return, is recorded using one or more receivers disposed on or above the subsurface region of the Earth. The seismic data recorded by the receivers may then be used to create an image or profile of the corresponding subsurface region. Upon creation of an image or profile of a subsurface region, these images and/or profiles can be used to interpret characteristics of a formation.

### BRIEF SUMMARY OF THE DISCLOSURE

An embodiment of a method for performing stochastic inversion on seismic data to estimate subsurface properties and their associated uncertainties comprises (a) generating an initial subsurface model having an initial dimensionality and based at least in part on initial seismic data, (b) compressing the initial model subsurface model to reduce a dimensionality of the initial subsurface model and form a compressed subsurface model having a compressed dimensionality that is less than the initial dimensionality, (c) producing an initial plurality of particles from the compressed subsurface model at the compressed dimensionality, (d) selecting particles from the initial plurality of particles, (e) expanding the selected particles to return the selected particles to the initial dimensionality, (f) iteratively updating a value of each particle of the selected particles utilizing synthetic seismic data produced from the initial subsurface model to generate a posterior set of particles, and (g) outputting the posterior set of particles as a target distribution comprising a plurality of inverted subsurface models. In some embodiments, the plurality of inverted subsurface models comprises full waveform inversion models. In some embodiments, (b) comprises applying an image segmentation function to the initial subsurface model to generate a segmented subsurface model defined by a lesser amount of data than the initial subsurface model. In certain embodiments, (b) comprises applying a K-means image segmentation function to the initial subsurface model whereby pixels of the initial subsurface model are grouped into separate clusters. In certain embodiments, (b) comprises applying a data compression function to the initial subsurface model to generate the compressed subsurface model defined by a lesser amount of data than the initial subsurface model. In some embodiments, (b) comprises applying a data compression function to the initial subsurface model whereby at least some of a plurality of geometric features of the initial subsurface model are approximated by compressed geometric features having predefined geometric elements. In some embodiments, the compressed geometric features comprise B-spline curves and the geometric elements comprise one or more control points and one or more knot vectors. In certain embodiments, (b) comprises (b1) applying an image segmentation function to the initial subsurface model to generate a segmented subsurface model defined by a lesser amount of data than the initial subsurface model, and (b2) applying a data compression function to the segmented subsurface model to generate the compressed subsurface model defined by a lesser amount of data than the segmented subsurface model.

An embodiment of a method for performing stochastic inversion on seismic data to estimate subsurface properties and their associated uncertainties comprises (a) generating an initial subsurface model based at least in part on initial seismic data, (b) applying at least one of an image segmentation function and a geometric data compression function to the initial subsurface model to generate a compressed subsurface model, (c) producing an initial plurality of particles from the compressed subsurface model, (d) selecting particles from the initial plurality of particles, (e) iteratively updating a value of each particle of the selected particles utilizing synthetic seismic data produced from the initial subsurface model to generate a posterior set of particles, and (f) outputting the posterior set of particles as a target distribution comprising a plurality of inverted subsurface models. In certain embodiments, the plurality of inverted subsurface models comprises full waveform inversion models. In some embodiments, (b) comprises applying the image segmentation function to the initial subsurface model to generate a segmented subsurface model having a reduced dimensionality with respect to a dimensionality of the initial subsurface model.

(b) comprises applying the data compression function to the initial subsurface model to generate the compressed subsurface model having a reduced dimensionality with respect to the initial subsurface model. In some embodiments, (b) comprises (b1) applying the image segmentation function to the initial subsurface model to generate a segmented subsurface model defined by a lesser amount of data than the initial subsurface model, and (b2) applying the data compression function to the segmented subsurface model to generate the compressed subsurface model defined by a lesser amount of data than the segmented subsurface model.

An embodiment of a method for performing stochastic inversion on seismic data to estimate subsurface properties and their associated uncertainties comprises (a) generating an initial subsurface model having an initial dimensionality and based at least in part on initial seismic data, (b) compressing the initial subsurface model to reduce a dimensionality of the initial subsurface model and form a compressed subsurface model having a compressed dimensionality that is less than the initial dimensionality, (c) perturbing the compressed subsurface model to produce a plurality of compressed model perturbations at the compressed dimensionality, (d) expanding the plurality of compressed model perturbations to the initial dimensionality to produce a plurality of expanded model perturbations, (e) combining the plurality of expanded model perturbations with the initial subsurface model to produce an initial plurality of particles, (f) selecting particles from the initial plurality of particles, (g) iteratively updating a value of each particle of the selected particles utilizing synthetic seismic data produced from the initial subsurface model to generate a posterior set of particles, and (h) outputting the posterior set of particles as a target distribution comprising a plurality of inverted subsurface models. In certain embodiments, the plurality of inverted subsurface models comprises full waveform inversion models. In certain embodiments, (b) comprises applying an image segmentation function to the initial subsurface model to generate a segmented subsurface model defined by a lesser amount of data than the initial subsurface model. In some embodiments, (b) comprises applying a K-means image segmentation function to the initial subsurface model whereby pixels of the initial subsurface model are grouped into separate clusters. In some embodiments, (b) comprises applying a data compression function to the initial subsurface model to generate the compressed subsurface model defined by a lesser amount of data than the initial subsurface model. In certain embodiments, (b) comprises applying a data compression function to the initial subsurface model whereby at least some of a plurality of geometric features of the initial subsurface model are approximated by compressed geometric features having predefined geometric elements. In certain embodiments, the compressed geometric features comprise B-spline curves and the geometric elements comprise one or more control points and one or more knot vectors.

Embodiments described herein comprise a combination of features and characteristics intended to address various shortcomings associated with certain prior devices, systems, and methods. The foregoing has outlined rather broadly the features and technical characteristics of the disclosed embodiments in order that the detailed description that follows may be better understood. The various characteristics and features described above, as well as others, will be readily apparent to those skilled in the art upon reading the following detailed description, and by referring to the accompanying drawings. It should be appreciated that the conception and the specific embodiments disclosed may be readily utilized as a basis for modifying or designing other structures for carrying out the same purposes as the disclosed embodiments. It should also be realized that such equivalent constructions do not depart from the spirit and scope of the principles disclosed herein.

### BRIEF DESCRIPTION OF THE DRAWINGS

For a detailed description of exemplary embodiments of the disclosure, reference will now be made to the accompanying drawings in which:

FIG. 1 illustrates a flow chart of various processes that may be performed based on analysis of seismic data acquired via a seismic survey system;

FIG. 2 illustrates a marine survey system in a marine environment;

FIG. 3 illustrates a land survey system in a land environment;

FIG. 4 illustrates a computing system that may perform operations described herein based on data acquired via the marine survey system of FIG. 2 and/or the land survey system of FIG. 3;

FIG. 5 illustrates a flowchart of a method for performing stochastic inversion on processed seismic data in order to estimate subsurface properties and their associated uncertainties using a plurality of compressed initial models defining a compressed model space is shown according to some embodiments;

FIG. 6 illustrates an initial subsurface model according to some embodiments;

FIG. 7 illustrates a segmented subsurface model according to some embodiments;

FIG. 8 illustrates a compressed subsurface model according to some embodiments;

FIG. 9 illustrates schematically a posterior distribution of inverted models that sample a prior distribution according to some embodiments;

FIG. 10 illustrates a flowchart of a method for performing stochastic inversion on seismic data to estimate subsurface properties and their associated uncertainties according to some embodiments;

FIG. 11 illustrates a flowchart of another method for performing stochastic inversion on seismic data to estimate subsurface properties and their associated uncertainties according to some embodiments; and

FIG. 12 illustrates a flowchart of another method for performing stochastic inversion on seismic data to estimate subsurface properties and their associated uncertainties according to some embodiments.

### DETAILED DESCRIPTION OF THE DISCLOSED EMBODIMENTS

The following discussion is directed to various exemplary embodiments. However, one skilled in the art will understand that the examples disclosed herein have broad application, and that the discussion of any embodiment is meant only to be exemplary of that embodiment, and not intended to suggest that the scope of the disclosure, including the claims, is limited to that embodiment.

Certain terms are used throughout the following description and claims to refer to particular features or components. As one skilled in the art will appreciate, different persons may refer to the same feature or component by different names. This document does not intend to distinguish between components or features that differ in name but not function. The drawing figures are not necessarily to scale. Certain features and components herein may be shown exaggerated in scale or in somewhat schematic form and some details of conventional elements may not be shown in interest of clarity and conciseness.

In the following discussion and in the claims, the terms “including” and “comprising” are used in an open-ended fashion, and thus should be interpreted to mean “including, but not limited to . . . ” Also, the term “couple” or “couples” is intended to mean either an indirect or direct connection. Thus, if a first device couples to a second device, that connection may be through a direct connection, or through an indirect connection via other devices, components, and connections. In addition, as used herein, the terms “axial” and “axially” generally mean along or parallel to a central axis (e.g., central axis of a body or a port), while the terms “radial” and “radially” generally mean perpendicular to the central axis. For instance, an axial distance refers to a distance measured along or parallel to the central axis, and a radial distance means a distance measured perpendicular to the central axis.

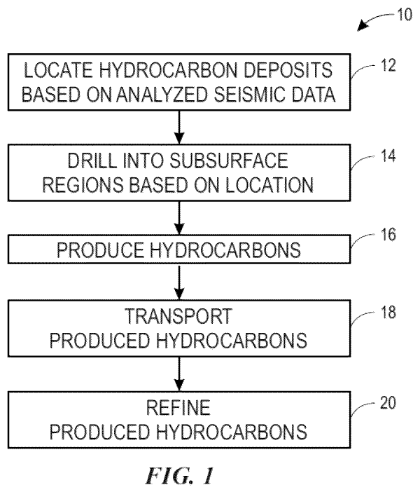

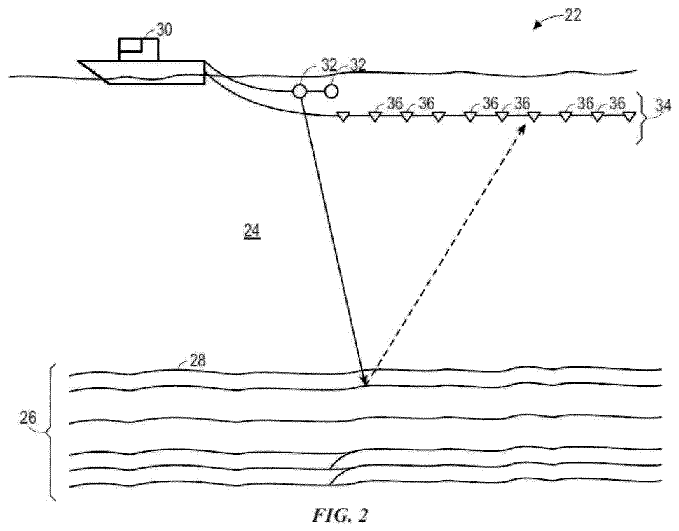

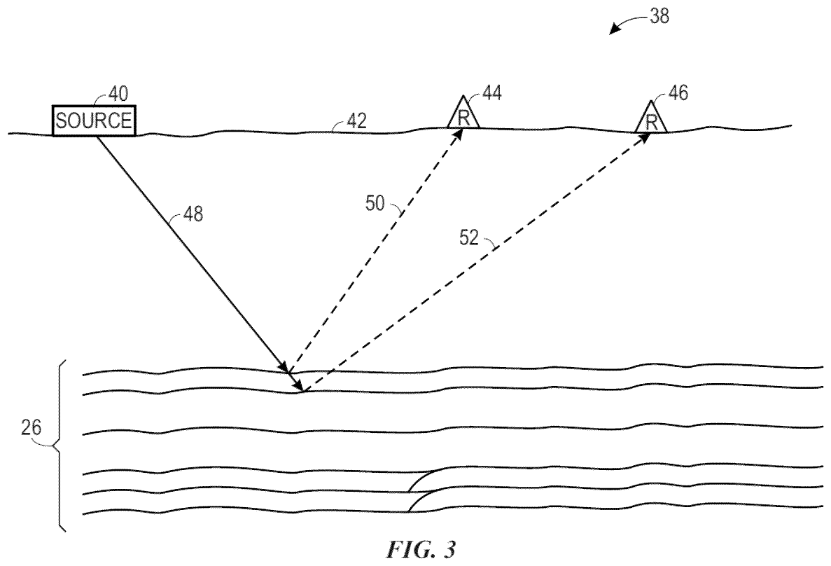

By way of introduction, seismic data may be acquired using a variety of seismic survey systems and methods, two of which are discussed with respect to FIG. 2 and FIG. 3. Regardless of the seismic data gathering method utilized, after the seismic data is acquired, a computing system may analyze the acquired seismic data and may use the results of the seismic data analysis (e.g., seismogram, map of geological formations, etc.) to perform various operations within the hydrocarbon exploration and production industries. For instance, FIG. 1 illustrates a flow chart of a method 10 that details various processes that may be undertaken based on the analysis of the acquired seismic data. Although the method 10 is described in a particular order, it should be noted that the method 10 may be performed in any suitable order.

Referring now to FIG. 1, at block 12, locations and properties of hydrocarbon deposits within a subsurface region of the Earth associated with the respective seismic survey may be determined based on the analyzed seismic data. In one embodiment, the seismic data acquired may be analyzed to generate a map or profile that illustrates various geological formations within the subsurface region. Based on the identified locations and properties of the hydrocarbon deposits, at block 14, certain positions or parts of the subsurface region may be explored. That is, hydrocarbon exploration organizations may use the locations of the hydrocarbon deposits to determine locations at the surface of the subsurface region to drill into the Earth. As such, the hydrocarbon exploration organizations may use the locations and properties of the hydrocarbon deposits and the associated overburdens to determine a path along which to drill into the Earth, how to drill into the Earth, and the like.

After exploration equipment has been placed within the subsurface region, at block 16, the hydrocarbons that are stored in the hydrocarbon deposits may be produced via natural flowing wells, artificial lift wells, and the like. At block 18, the produced hydrocarbons may be transported to refineries and the like via transport vehicles, pipelines, and the like. At block 20, the produced hydrocarbons may be processed according to various refining procedures to develop different products using the hydrocarbons.

It should be noted that the processes discussed with regard to the method 10 may include other suitable processes that may be based on the locations and properties of hydrocarbon deposits as indicated in the seismic data acquired via one or more seismic survey. As such, it should be understood that the processes described above are not intended to depict an exhaustive list of processes that may be performed after determining the locations and properties of hydrocarbon deposits within the subsurface region.

With the foregoing in mind, FIG. 2 is a schematic diagram of a marine survey system 22 (e.g., for use in conjunction with block 12 of FIG. 1) that may be employed to acquire seismic data (e.g., waveforms) regarding a subsurface region of the Earth in a marine environment. Generally, a marine seismic survey using the marine survey system 22 may be conducted in an ocean 24 or other body of water over a subsurface region 26 of the Earth that lies beneath a seafloor 28.

The marine survey system 22 may include a vessel 30, one or more seismic sources 32, a (seismic) streamer 34, one or more (seismic) receivers 36, and/or other equipment that may assist in acquiring seismic images representative of geological formations within a subsurface region 26 of the Earth. The vessel 30 may tow the seismic source(s) 32 (e.g., an air gun array) that may produce energy, such as sound waves (e.g., seismic waveforms), that is directed at a seafloor 28. The vessel 30 may also tow the streamer 34 having a receiver 36 (e.g., hydrophones) that may acquire seismic waveforms that represent the energy output by the seismic source(s) 32 subsequent to being reflected off of various geological formations (e.g., salt domes, faults, folds, etc.) within the subsurface region 26. Additionally, although the description of the marine survey system 22 is described with one seismic source 32 (represented in FIG. 2 as an air gun array) and one receiver 36 (represented in FIG. 2 as a set of hydrophones), it should be noted that the marine survey system 22 may include multiple seismic sources 32 and multiple receivers 36. In the same manner, although the above descriptions of the marine survey system 22 is described with one seismic streamer 34, it should be noted that the marine survey system 22 may include multiple streamers similar to streamer 34. In addition, additional vessels 30 may include additional seismic source(s) 32, streamer(s) 34, and the like to perform the operations of the marine survey system 22.

FIG. 3 is a block diagram of a land survey system 38 (e.g., for use in conjunction with block 12 of FIG. 1) that may be employed to obtain information regarding the subsurface region 26 of the Earth in a non-marine environment. The land survey system 38 may include a land-based seismic source 40 and land-based receiver 44. In some embodiments, the land survey system 38 may include multiple land-based seismic sources 40 and one or more land-based receivers 44 and 46. Indeed, for discussion purposes, the land survey system 38 includes a land-based seismic source 40 and two land-based receivers 44 and 46. The land-based seismic source 40 (e.g., seismic vibrator) that may be disposed on a surface 42 of the Earth above the subsurface region 26 of interest. The land-based seismic source 40 may produce energy (e.g., sound waves, seismic waveforms) that is directed at the subsurface region 26 of the Earth. Upon reaching various geological formations (e.g., salt domes, faults, folds) within the subsurface region 26 the energy output by the land-based seismic source 40 may be reflected off of the geological formations and acquired or recorded by one or more land-based receivers (e.g., 44 and 46).

In some embodiments, the land-based receivers 44 and 46 may be dispersed across the surface 42 of the Earth to form a grid-like pattern. As such, each land-based receiver 44 or 46 may receive a reflected seismic waveform in response to energy being directed at the subsurface region 26 via the seismic source 40. In some cases, one seismic waveform produced by the seismic source 40 may be reflected off of different geological formations and received by different receivers. For example, as shown in FIG. 3, the seismic source 40 may output energy that may be directed at the subsurface region 26 as seismic waveform 48. A first receiver 44 may receive the reflection of the seismic waveform 48 off of one geological formation and a second receiver 46 may receive the reflection of the seismic waveform 48 off of a different geological formation. As such, the first receiver 44 may receive a reflected seismic waveform 50 and the second receiver 46 may receive a reflected seismic waveform 52.

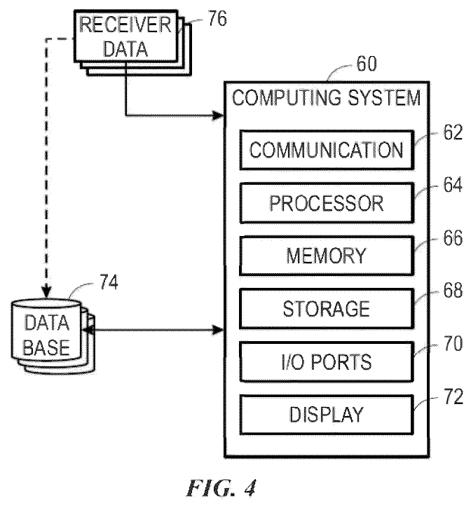

Regardless of how the seismic data is acquired, a computing system (e.g., for use in conjunction with block 12 of FIG. 1) may analyze the seismic waveforms acquired by the receivers 36, 44, 46 to determine seismic information regarding the geological structure, the location and property of hydrocarbon deposits, and the like within the subsurface region 26. FIG. 4 is a block diagram of an example of such a computing system 60 that may perform various data analysis operations to analyze the seismic data acquired by the receivers 36, 44, 46 to determine the structure and/or predict seismic properties of the geological formations within the subsurface region 26.

Referring now to FIG. 4, the computing system 60 may include a communication component 62, a processor 64, memory 66, storage 68, input/output (I/O) ports 70, and a display 72. In some embodiments, the computing system 60 may omit one or more of the display 72, the communication component 62, and/or the input/output (I/O) ports 70. The communication component 62 may be a wireless or wired communication component that may facilitate communication between the receivers 36, 44, 46, one or more databases 74, other computing devices, and/or other communication capable devices. In one embodiment, the computing system 60 may receive receiver data 76 (e.g., seismic data, seismograms, etc.) via a network component, the database 74, or the like. The processor 64 of the computing system 60 may analyze or process the receiver data 76 to ascertain various features regarding geological formations within the subsurface region 26 of the Earth.

The processor 64 may be any type of computer processor or microprocessor capable of executing computer-executable code. The processor 64 may also include multiple processors that may perform the operations described below. The memory 66 and the storage 68 may be any suitable articles of manufacture that can serve as media to store processor-executable code, data, or the like. These articles of manufacture may represent computer-readable media (e.g., any suitable form of memory or storage) that may store the processor-executable code used by the processor 64 to perform the presently disclosed methods. Generally, the processor 64 may execute software applications that include programs that process seismic data acquired via receivers of a seismic survey according to the embodiments described herein.

The memory 66 and the storage 68 may also be used to store the data, analysis of the data, the software applications, and the like. The memory 66 and the storage 68 may represent non-transitory computer-readable media (e.g., any suitable form of memory or storage) that may store the processor-executable code used by the processor 64 to perform various methods described herein. It should be noted that non-transitory merely indicates that the media is tangible and not a signal.

The I/O ports 70 may be interfaces that may couple to other peripheral components such as input devices (e.g., keyboard, mouse), sensors, input/output (I/O) modules, and the like. I/O ports 70 may enable the computing system 60 to communicate with the other devices in the marine survey system 22, the land survey system 38, or the like via the I/O ports 70.

The display 72 may depict visualizations associated with software or executable code being processed by the processor 64. In one embodiment, the display 72 may be a touch display capable of receiving inputs from a user of the computing system 60. The display 72 may also be used to view and analyze results of the analysis of the acquired seismic data to determine the geological formations within the subsurface region 26, the location and property of hydrocarbon deposits within the subsurface region 26, predictions of seismic properties associated with one or more wells in the subsurface region 26, and the like. The display 72 may be any suitable type of display, such as a liquid crystal display (LCD), plasma display, or an organic light emitting diode (OLED) display, for example. In addition to depicting the visualization described herein via the display 72, it should be noted that the computing system 60 may also depict the visualization via other tangible elements, such as paper (e.g., via printing) and the like.

With the foregoing in mind, the present methods described herein may also be performed using a supercomputer that employs multiple computing systems 60, a cloud-computing system, or the like to distribute processes to be performed across multiple computing systems 60. In this case, each computing system 60 operating as part of a super computer may not include each component listed as part of the computing system 60. For example, each computing system 60 may not include the display 72 since multiple displays 72 may not be useful to for a supercomputer designed to continuously process seismic data.

After performing various types of seismic data processing, the computing system 60 may store the results of the analysis in one or more databases 74. The databases 74 may be communicatively coupled to a network that may transmit and receive data to and from the computing system 60 via the communication component 62. In addition, the databases 74 may store information regarding the subsurface region 26, such as previous seismograms, geological sample data, seismic images, and the like regarding the subsurface region 26.

Although the components described above have been discussed with regard to the computing system 60, it should be noted that similar components may make up the computing system 60. Moreover, the computing system 60 may also be part of the marine survey system 22 or the land survey system 38, and thus may monitor and control certain operations of the seismic sources 32 or 40, the receivers 36, 44, 46, and the like. Further, it should be noted that the listed components are provided as example components and the embodiments described herein are not to be limited to the components described with reference to FIG. 4.

In some embodiments, the computing system 60 may generate a two-dimensional representation or a three-dimensional representation of the subsurface region 26 based on the seismic data received via the receivers mentioned above. Additionally, seismic data associated with multiple source/receiver combinations may be combined to create a near continuous profile of the subsurface region 26 that can extend for some distance. In a two-dimensional (2-D) seismic survey, the receiver locations may be placed along a single line, whereas in a three-dimensional (3-D) survey the receiver locations may be distributed across the surface in a grid pattern. As such, a 2-D seismic survey may provide a cross sectional picture (vertical slice) of the Earth layers as they exist directly beneath the recording locations. A 3-D seismic survey, on the other hand, may create a data “cube” or volume that may correspond to a 3-D picture of the subsurface region 26.

In addition, a 4-D (or time-lapse) seismic survey may include seismic data acquired during a 3-D survey at multiple times. Using the different seismic images acquired at different times, the computing system 60 may compare the two images to identify changes in the subsurface region 26.

In any case, a seismic survey may be composed of a very large number of individual seismic recordings or traces. As such, the computing system 60 may be employed to analyze the acquired seismic data to obtain an image representative of the subsurface region 26 and to determine locations and properties of hydrocarbon deposits. To that end, a variety of seismic data processing algorithms may be used to remove noise from the acquired seismic data, migrate the pre-processed seismic data, identify shifts between multiple seismic images, align multiple seismic images, and the like.

After the computing system 60 analyzes the acquired seismic data, the results of the seismic data analysis (e.g., seismogram, seismic images, map of geological formations, etc.) may be used to perform various operations within the hydrocarbon exploration and production industries. For instance, as described above, the acquired seismic data may be used to perform the method 10 of FIG. 1 that details various processes that may be undertaken based on the analysis of the acquired seismic data.

In some embodiments, the results of the seismic data analysis may be generated in conjunction with a seismic processing scheme that includes seismic data collection, editing of the seismic data, initial processing of the seismic data, signal processing, conditioning, and imaging (which may, for example, include production of imaged sections or volumes (which may, for example, include production of imaged sections or volumes) in prior to any interpretation of the seismic data, any further image enhancement consistent with the exploration objectives desired, generation of attributes from the processed seismic data, reinterpretation of the seismic data as needed, and determination and/or generation of a drilling prospect or other seismic survey applications. As a result, location of hydrocarbons within a subsurface region 26 may be identified. Methods for detecting subsurface features (such as, for example, faults) from the seismic data/images will be described in greater detail below.

Generally, inversion methods are employed to extract detailed and accurate information regarding subsurface features whereby observed seismic data may be transformed into meaningful subsurface models. Particularly, inversion methods may be employed to tune subsurface models whereby synthetic (e.g., modeled) seismic data generated by the subsurface models accurately reflects the observed seismic data. In some applications, an inversion method referred to as Full-Waveform Inversion (FWI) may be used to estimate the properties of the subsurface. Particularly, FWI may be employed to minimize a misfit between observed and synthetic seismic data in order to produce accurate and detailed images of subsurface features.

Due to non-linear relationships between the observed seismic data and the modeled data, inaccurate physics, and inadequate coverage, the problem of FWI is under-determined and therefore subsurface models produced through the application of FWI methods can carry significant uncertainty. To state in other words, FWI methods can suffer from non-uniqueness, where multiple subsurface models may fit the observed seismic data equally well, leading to ambiguity in interpretation. Particularly, noisy and incomplete observed seismic data may lead to significant uncertainty in the resulting subsurface model. In some applications, stochastic inversion methods are employed to address the (sometimes) significant uncertainty carried by the subsurface model. Specifically, stochastic inversion methods consider a range of possible methods to provide a probabilistic “posterior distribution” of model parameters (e.g., parameters of the subsurface model), mitigating the impact of incomplete or noisy observed seismic data.

Specifically, stochastic inversion methods generally apply a likelihood function to a prior distribution of model parameters to provide the posterior distribution of model parameters. The prior distribution of model parameters represent existing information or beliefs about the model parameters based on geological knowledge, well data, or any other relevant information available before conducting a seismic survey of the subsurface region, and represents an initial uncertainty of the model parameters. The likelihood function represents a probability of observing a given set of seismic data given a particular set of model parameters, and is calculated using the physics of wave propagation and the relationship between the model parameters and the observed seismic data. The posterior distribution produced by the stochastic inversion method is derived through Bayes' theorem which, in this instance, relates the prior distribution, the likelihood function, and the observed seismic data, where the posterior distribution is proportional to the product of the likelihood function and the prior distribution. The posterior distribution of model parameters represents our updated knowledge of the model parameters following incorporation of the observed seismic data, and comprises a probability distribution (e.g., in the form of a probability density function (PDF)) that reflects the combined influence of prior information (e.g., derived from the prior distribution) and the observed seismic data. Additionally, the posterior distribution provides information about the most likely values of the model parameters as well as their associated uncertainties. To make such stochastic inversion methods feasible for practical applications, stochastic inversion methods typically employ sampling methods (e.g., Markov Chain Monte Carlo or ensemble-based methods) to draw samples from the posterior distribution, with such samples being used to characterize uncertainty in the estimated model parameters.

While stochastic inversion methods may provide valuable insight by capturing the posterior distribution of subsurface model parameters to quantify their uncertainty, stochastic inversion methods often suffer from limited applicability due to their substantial computational cost and complexity. The computational cost and complexity of stochastic inversion methods may particularly limit their applicability with respect to real-time and/or large-scale seismic exploration applications.

Specifically, stochastic inversion methods can be computationally expensive, particularly when dealing with high-dimensional parameter spaces or when a large number of simulations is required to adequately sample the posterior distribution given that multiple forward simulations or model evaluations are often required for sampling the parameter space, which contributes to the computational burden. Additionally, in many geological applications, subsurface models involve a large number of parameters, leading to such high-dimensional parameter spaces. Exploring high-dimensional parameter spaces correspondingly requires an extensive number of simulations, exacerbating the issue of computational cost whereby computational demands increase exponentially with the number of parameters.

In some applications, specialized sampling methods or algorithms are employed for sampling the posterior distribution in an effort to reign in some of the computational costs associated with stochastic inversion methods. Particularly, a sampling method referred to as Stein-Variation Gradient Descent (SVGD) method may be employed to sample the posterior distribution where the SVGD method uses a set of so-called “particles” to iteratively optimize their positions in the parameter space to match a target distribution. SVGD is particularly configured to handle high-dimensional parameter spaces and is often employed in Bayesian inversion frameworks to obtain a representative sample set from a posterior distribution.

To provide a brief example of a conventional SVGD method, initially a probabilistic model is defined that relates the subsurface model parameters to the observed seismic data which includes defining the likelihood function which represents the probability of observing the seismic data given the model parameters and which specifies a prior distribution reflecting prior knowledge or beliefs about the model parameters. With the probabilistic model defined, a set of particles are initialized in the parameter space where the particles represent samples drawn from a rudimentary initial distribution (e.g., a Gaussian distribution). Subsequently, the Stein gradient is calculated which measures the discrepancy between the set of particles of the current iteration and the target distribution (e.g., the true posterior distribution). The positions of the particles in the parameter space may then be adjusted or updated based on the determined Stein gradient whereby the Stein discrepancy is minimized by moving the particles towards a configuration that better approximates the target distribution. The determination of the Stein discrepancy and the updating of the particle positions may be repeated iteratively until the particles converge to a configuration that closely matches the target posterior distribution. The number of iterations may be determined based on convergence criteria or a predefined number of steps. Once convergence has been achieved, the final set of particles can be considered as samples from the approximated posterior distribution. These samples provide a representation of the uncertainty in the subsurface model parameters given the observed seismic data.

While SVGD methods are intended to maximize the computational efficiency of stochastic inversion methods, their performance is still influenced by the complexity of the inversion problem and number of model parameters (high dimensional model parameter spaces require large number of particles to effectively sample the posterior distribution). Thus, while specialized sampling methods like SVGD methods may assist in increasing the computational efficiency of stochastic inversion methods, they are limited in the benefits (e.g., with respect to minimizing computational cost and complexity) they can provide and do not address the underlying issues that result from high-dimensional parameter spaces. Particularly, SVGD typically uses an ensemble of models (that samples the prior distribution) as a starting point for inversion and then produces an ensemble of inverted models that represent the posterior distribution. Given that, for each iteration, SVGD methods compute the gradient for all subsurface models, SVGD methods can be extremely costly to implement. For example, for the chosen initial models to adequately sample the prior distribution, the number of models should be proportional to the dimensionality of the given problem (e.g., the given parameter space). Conventionally, this is be accomplished through the costly and complex process of using a large number of models (e.g., millions of models for industrial scale applications). Conventional approaches for building a prior distribution of particles include making point-by-point (or local) perturbations to the average starting model. Each of these perturbations may be considered independent of one another. However, when dealing with the subsurface, while the typical model space is very large, there is a significant degree of structure present conventional approaches fail to utilize.

Accordingly, embodiments of systems and methods for efficiently performing stochastic inversion methods in seismic exploration applications are described herein. Certain embodiments of the present disclosure implement an efficient strategy to significantly reduce the computational cost and deliver meaningful estimates of uncertainty. In addition, certain embodiments of the present disclosure implement SVGD methods to estimate the posterior distribution of model parameters.

In some embodiments, systems and methods disclosed herein may compress an initial subsurface model or perturbations produced therefrom by employing a dimensionality reduction framework to the parameter space. Particularly, subsurface models are defined by a plurality of unique dimensions each comprising a unique set of coefficients or “points,” where the number of dimensions and the number of points for each of the dimensions determines the dimensionality of the subsurface model. As used herein, the phrase “reducing the dimensionality” of a subsurface model refers to reducing the number of points for at least one of the dimensions of the subsurface model. For example, in some embodiments, a given dimension of an initial subsurface model may contain a large number of points which may instead be represented by a smaller number of points to thereby compress the subsurface model (or model perturbations thereof as will be discussed further herein) and reduce the dimensionality thereof.

In this manner, computational costs and complexities stemming from higher-dimensional parameter spaces may be addressed directly by reducing the dimensionality of the parameter space. For example, subsurface models are typically highly-structured and the totality of points that represent the subsurface model are not mutually independent. Given this lack of mutual independence, the parameter space may be compressed without compromising the quality of the product of the method (e.g., the final or posterior set of particles) so as to substantially reduce the computational costs and complexity in performing stochastic inversion. Particularly, certain embodiments of the present disclosure compress the parameter space by making use of this property: first, certain embodiments of the present disclosure apply image segmentation (e.g., k-means) on the initial subsurface model to identify geological elements and only consider those as independent variables; second, certain embodiments of the present disclosure use b-spline basis to compress the model/model perturbations. Both methods significantly reduce the dimensionality of the problem and therefore make sampling of prior computationally tractable.

In some embodiments, image segmentation is applied to the initial subsurface model/model perturbations where the initial subsurface model is in the form of a Marmousi model illustrating velocity (via a heatmap) as a function of depth and distance (e.g., offset distance). Image segmentation partitions the Marmousi model into distinct, non-overlapping regions based on pixel similarity (similarity between pixels of the heatmap forming the Marmousi model). In certain embodiments, a K-means image segmentation is applied to the subsurface model (e.g., the Marmousi model) whereby pixels of the model are grouped into “K” clusters, where “K” is a user-defined parameter representing a desired number of distinct segments or regions in the model. In this manner, the image segmentation applied to the initial subsurface model facilitates compression of the initial subsurface model by grouping similar pixels together and representing them with a single value, minimizing redundancy.

In certain embodiments, a geometric data compression function to the initial subsurface model/model perturbations to compress the initial subsurface model/model perturbations. In some instances, the geometric data compression function may be applied to the initial subsurface model following the application of image segmentation to the initial subsurface model. In some embodiments, the geometric data compression function comprises a B-spline data compression function in which geometric features of the initial subsurface model are represented using B-spline curves defined by control points and a knot vector to provide a flexible representation of smooth curves. The geometric data compression function reduces or minimizes the amount of data required to represent geometric features (shapes, curves, etc.) present in the initial subsurface model (e.g., geometric features present in the initial subsurface model that is in the form of a Marmousi model) while maintaining an acceptable level of accuracy. The geometric data compression may thus reduce the complexity of the initial subsurface model without jeopardizing the quality of the product of the method (e.g., the final or posterior set of particles) so as to substantially reduce the computational costs and complexity in performing stochastic inversion. In some embodiments, image segmentation and geometric data compression may each be applied to the initial subsurface model (e.g., with geometric data compression following image segmentation) to further minimize the complexity and/or dimensionality of the resulting compressed subsurface model/compressed model perturbations.

As described above, the problem set up for FWI is non-linear, under-determined and often non-convex. This implies non-uniqueness of solutions, and therefore, uncertainty. Two possible expressions of non-uniqueness are (1) being trapped in a local minimum and (2) the null space, i.e., several models that equally satisfy the data misfit. Certain embodiments of the present disclosure use SVGD FWI to address this issue. Certain embodiments of the present disclosure share results on a synthetic Marmousi model. As outlined above, certain embodiments of the present disclosure first compress the model using k-means image segmentation or using a b-spline basis. It may be understood that other algorithms for compression can also be used.

In addition, this step significantly reduces the dimensionality of model space and the number of models that are now required to adequately sample the prior distribution is far fewer. For example, a subsurface model may contain a plurality of separate dimensions each including a unique set of points (e.g., hundreds of points per dimension). Compression of the subsurface model substantially reduces the number of points per dimension (e.g., tens of points rather than hundreds of points per dimension), resulting in an even greater overall reduction in the number of points forming the compressed subsurface model (e.g., a thousand-fold or greater compression for three-dimensional (3D) models). This may be accomplished, for example, by representing the large set of points of the subsurface model with a limited number of coefficients. Given that the number of models required to adequately represent all of the possibilities of a given model space is directly proportional to the size of the model space, compression of the model space (e.g., via the compression of individual models of the model space) reduces, in-turn, the number of models that must be used to sample the prior distribution.

Certain embodiments of the present disclosure then run FWI starting with an ensemble of models. Several of the starting models get stuck in the local minima, however, several models converge very close to the true solution. In practice, certain embodiments of the present disclosure rarely run the inversion such that the misfit is numerically zero and due to the presence of a huge null space, certain embodiments of the present disclosure end up with many different models with equivalent misfit. Obtaining these models via SVGD allows for constructing the posterior probability distribution of the solution space.

Certain embodiments of the present disclosure seek to emphasize that running SVGD FWI is different from scenario testing. Here, all the inversions are not independent of each other, they estimate the posterior distribution while minimizing the KL divergence.

Estimating uncertainty associated with FWI is an attractive but expensive proposition. Variational inference methods are very effective at estimating the posterior probability of an inverse problem. However, the dimensionality of FWI can make it computationally intractable to do so. Subsurface has a lot of structure and symmetry and considering each point as being completely independent of another is not optimal. Certain embodiments of the present disclosure can implement two different strategies that utilize this property and sample the prior distribution effectively with meaningful models.

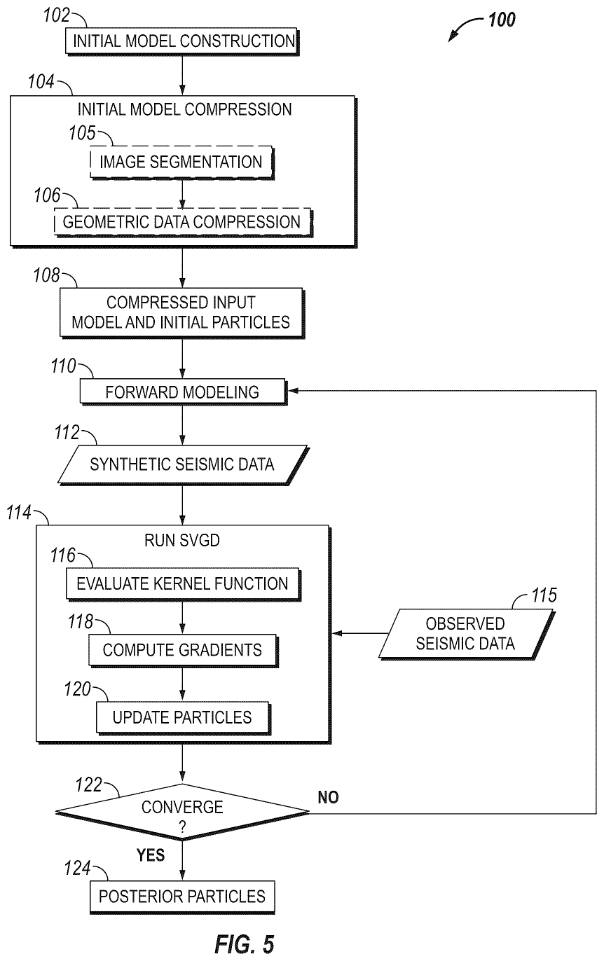

Referring now to FIG. 5, a method, illustrated as a method 100, for performing stochastic (e.g., Bayesian) inversion (e.g., a FWI inversion) on processed seismic data in order to estimate subsurface properties and their associated uncertainties using a of compressed subsurface model/compressed model perturbations is shown. This process can be performed on the computing system 60 to analyze acquired seismic data (e.g., performed as code stored on a tangible and non-transitory machine readable medium, such as the memory 66 and/or the storage 68, that when in operation causes the processor 64 to perform one or more of the steps of the method 100 as performance of the technique). Generally, method 100 includes block 102, which represents construction of one or more initial subsurface models at an initial dimensionality. The initial subsurface model can be a statistical model (e.g., encoded or presented in a mathematical function, representation, or parameterization). Block 102, as illustrated, may include various sub-processes. For example, in some embodiments, geological and petrophysical data (i.e., seismic data) is received by computing system 60 at block 102. Examples of this data may be well logs, geological descriptions (rock types, etc.), and geophysical data. In certain embodiments, block 102 includes training the initial subsurface model.

Probability distributions utilized in conjunction with the technique illustrated in FIG. 5 can be represented by a set of subsurface models, parameterized in terms of P-wave speed (Vp), S-wave speed (Vs), and density (e.g., density characteristics of a rock formation or type), and/or other physical representations of the subsurface which may be referred to collectively as particles. In some embodiments, the training of the initial subsurface model at block 102 (in some embodiments) includes the use of Gaussian, uniform, and/or Gaussian mixture models to generate statistical models as the initial subsurface model (or portions thereof).

In some embodiments, block 102 includes training one or more conditioned initial models (CIMs) should it be desired to condition initial particles on seismic data. That is, in some embodiments, there is an additional option to condition the initial subsurface model on input seismic data on a sample-by-sample basis. This CIM can be used to generate initial particles (e.g., different initial particles) (following compression of the CIM) which are distributed according to an approximation of the target posterior distribution, thus improving convergence of the optimization as, for example, an enhanced Gaussian mixture model. Training of the CIM may be undertaken based upon whether conditioning of the seismic data is desired which can be selected based on the desired results and/or efficiency, complexity, time, etc. to be undertaken with respect to block 102. However, it may be understood that in at least some embodiments training of the CIM is omitted from block 102.

At block 104, the initial subsurface model constructed at block 102 is compressed (or perturbations of the initial subsurface model are compressed) to reduce their dimensionality and/or complexity and thereby significantly reduce the computational cost associated with performing method 100. Particularly, the compressed subsurface model (or compressed model perturbations) are at a compressed dimensionality that is less than an expanded dimensionality of the initial subsurface model. The initial subsurface model constructed at block 102 may include several dimensions each comprising hundreds of unique points. These points model characteristics of rocks of a subsurface region which, generally, is highly structured in the form of stacked rock layers. The structure inherent in such subsurface regions may be leveraged to reduce the dimensionality of the corresponding subsurface model without materially reducing its accuracy. As but one example, a rock layer is present in a subsurface model that is approximately five pixels tall and 500 pixels wide, then such a subsurface model may be compressed by representing what would otherwise be 2,500 separate points (e.g., for the original subsurface model) with a single point.

In this exemplary embodiment, the compression of the initial subsurface model performed at block 104 includes applying image segmentation (block 105 of method 100) to the initial subsurface model and applying geometric data compression (block 106 of method 100) to the initial subsurface model. In this exemplary embodiment, block 106 follows (e.g., temporally) block 105; however, in other embodiments, the ordering of blocks 105 and 106 may be reversed). In still other embodiments, block 104 may include only image segmentation 105 or geometric data compression 106. In certain embodiments, block 104 may include at least one of image segmentation 105, geometric data compression 106, and/or other data compression functions.

Block 105 may comprise partitioning the initial subsurface model into distinct, non-overlapping regions based on pixel similarity of the initial subsurface model. In some embodiments, block 105 comprises applying K-means image segmentation to the initial subsurface model whereby pixels of the model are grouped into “K” clusters, where “K” is a predefined (e.g., user defined) parameter representing a desired number of distinct segments or regions in the model. In some embodiments, other forms of image segmentation may be employed at block 105 such as, for example, image segmentation techniques based on edge detection, trained neural nets and other machine learning techniques.

Block 106 comprises applying a geometric data compression function to the input model, such as the segmented initial subsurface model produced at block 105. As used herein, the term “geometric data compression function” refers to functions which replace one or more geometric features of a subsurface model with flexible, predefined (e.g., having one or more predefined elements) geometric features that approximate the original geometries of the geometric features to thereby reduce the overall amount of data required to form or represent the model. For example, subsurface models may contain extremely complex, irregular geometric features which require a substantial amount of data to represent. Such complex features may be “smoothed” using predefined geometric features while retaining their overall shape or contour to reduce the amount of data required to represent the given geometric feature. The geometric features used to smooth or simplify the complex geometric feature may vary depending on the given geometric data compression function employed at block 106.

In some embodiments, the geometric data compression function of block 106 comprises a B-spline data compression function in which geometric features of the initial subsurface model are represented using B-spline curves defined by control points and corresponding knot vectors. For example, at least some of the geometric features of a subsurface model may be represented by B-spline curves in order to minimize the data required to express the given model. In particular, initially, geometric data of the subsurface model may be represented using B-spline curves. The B-spline curves may then be parameterized based on their control points and knot vectors where the parameterization defines how the curves evolve over their domains. The parameterized curves may then be compressed to reduce the amount of data required to represent the B-spline curve. Various methods can be used for compression such as, for example, knot vector simplification (removal or merger of knots that do not significantly affect the shape of the curve), control point reduction (eliminating redundant or insignificant control points), and/or quantization (representing real-valued coordinates of control points with a limited set of discrete values). Finally, it may be understood that in other embodiments, geometric data compression functions other than B-spline functions may be applied at block 106.

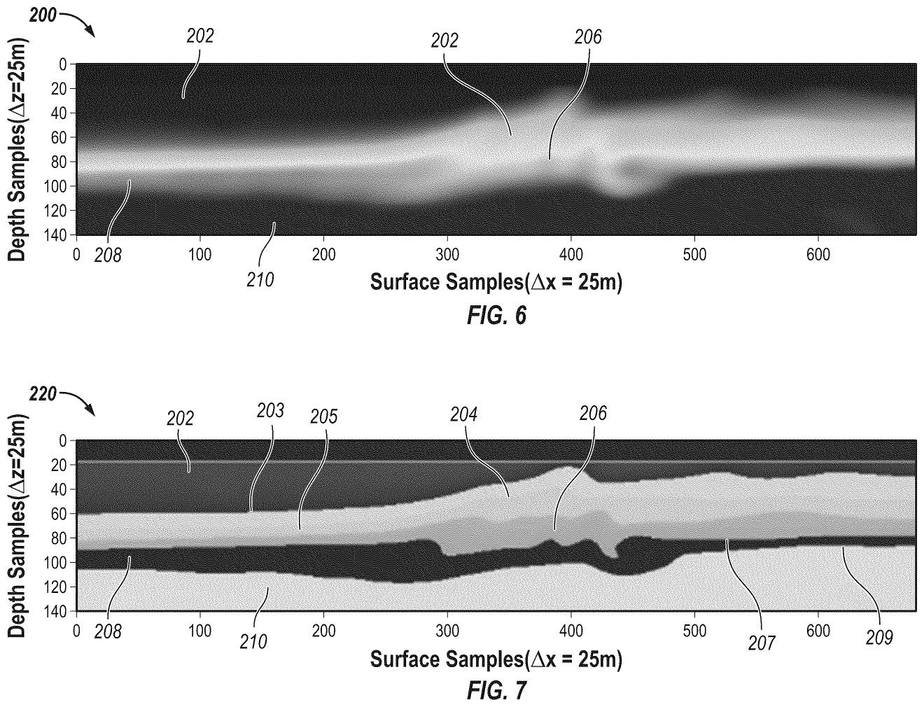

Referring briefly to FIGS. 6-8, an example of the application of image segmentation (e.g., block 105) applied to an initial subsurface model is shown. Particularly, FIG. 6 illustrates an exemplary input subsurface model 200 in the form of a Marmousi model or image illustrating seismic velocity (via a heatmap) as a function of depth (Y-axis of initial subsurface model 200) and distance (e.g., offset distance) (X-axis of initial subsurface model 200). In this configuration, the shade or color of each given pixel represents a simulated seismic velocity at a given depth and offset distance. Initial subsurface model 200 illustrates several distinct layers (vertically layered by depth) of strata of subsurface materials 202, 204, 206, 208, and 210, respectively, with increasing vertical depth. Seismic velocity within each layer 202, 204, 206, 208, and 210 varies pixel-by-pixel, increasing the complexity (e.g., in terms of the amount of data required to represent each given layer) of each layer 202, 204, 206, 208, and 210.

FIG. 7 illustrates a segmented subsurface model 220 corresponding to the initial subsurface model 200 following the application of image segmentation (e.g., image segmentation consistent with block 105 of method 100) thereto. As seen in FIG. 7, image segmentation “flattens” the initial subsurface model 200 such that the broad range of pixel shading found in initial subsurface model 200 has been reduced to a limited number of differently shaded groups of pixels (e.g., less than ten differently shaded groups of pixels). Particularly, in segmented subsurface model 220, the shading of the pixels defining each layer 202, 204, 206, 208, and 210 is similarly shaded (e.g., each pixel of layer 202 has the same shading, each pixel of layer 204 has the same shading, and so on and so forth). Thus, the image segmentation applied to initial subsurface model 220 reduces or flattens the variety in pixel shading for each successive layer 202, 204, 206, 208, and 210, thereby substantially reducing the data required to form segmented subsurface model 220 as compared to initial subsurface model 200 without sacrificing geological information contained in the initial subsurface model 200. For example, the geological features inherent in the shape and configuration of layers 202, 204, 206, 208, and 210 from initial subsurface model 200 is preserved in segmented subsurface model 220. In some embodiments, K-means image segmentation is applied to the initial subsurface model 200 whereby the different layers 202, 204, 206, 208, and 210 of segmented subsurface model 220 correspond to different K clusters.

It may also be noted in FIG. 7 that boundaries 203, 205, 207, and 209 between layers 202, 204, 206, 208, and 210, respectively, are more coherently defined in segmented subsurface model 220. The shape of boundaries 203, 205, 207, and 209 in segmented subsurface model 220 is rough and complex, thereby requiring a substantial amount of data to represent the complex boundaries 203, 205, 207, and 209 between the corresponding layers 202, 204, 206, 208, and 210.

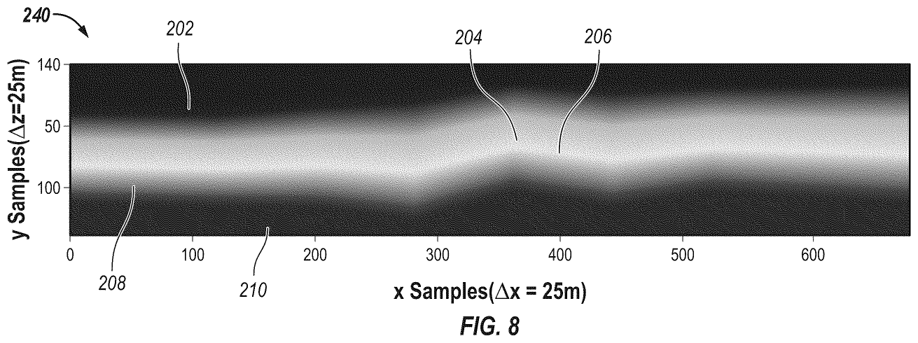

FIG. 8 illustrates a compressed subsurface model 240 corresponding to the segmented subsurface model 220 following the application of a geometric data compression function (e.g., a data compression function consistent with block 106 of method 100) thereto. As seen in FIG. 8, at least some of the geometric features of compressed subsurface model 240 have been simplified or “smoothed” from the segmented subsurface model 220 via the application of the geometric data compression function. For example, in some embodiments, the geometric data compression function replaces some of the geometric features of segmented subsurface model 220 with simplified geometric features (depending upon the given geometric data compression function applied to the model 220) to reduce the complexity of the segmented subsurface model 220 without markedly reducing the accuracy of the segmented subsurface model 220.

In this exemplary embodiment, the geometric data compression function applied to segmented subsurface model 220 comprises a B-spline data compression function in which geometric features (e.g., boundaries 203, 203, 205, 207, and 209 and/or other geometric features) of the compressed subsurface model 240 are represented using B-spline curves defined by control points and corresponding knot vectors to provide a flexible representation of the geometric features of compressed subsurface model 240. Particularly, the B-spline curves used to compress the compressed initial subsurface model 220 may smooth or approximate the more complex, irregular geometric features present in segmented subsurface model 220 using a fraction of the data such that the amount data required to represent or express compressed subsurface model 240 is substantially less than the amount of data required to represent or express segmented subsurface model 220, where the amount of data required to form model 220 is, in-turn, substantially less than the amount of data required to represent or express the original initial subsurface model 200.

Returning now to FIG. 5, in this exemplary embodiment, block 108 receives as an input, the compressed subsurface model from block 104, and therefrom produces initial particles as illustrated at block 108. The set of initial particles may be produced at block 108 by perturbing the compressed subsurface model. Particularly, one or more different points of the compressed subsurface model may be perturbed to produce the set of initial particles. Given the reduced dimensionality of the compressed subsurface model, the number of points that need be perturbed at block 108 is substantially reduced as compared to a similar perturbation of the original, expanded initial subsurface model (e.g., having a substantially greater number of particles than the compressed subsurface model).

The compression of the initial subsurface model that occurs at block 104 significantly reduces the dimensionality of the resulting compressed model space along with the number of compressed subsurface models required to adequately sample the prior distribution of the compressed model space. Particularly, the compressed subsurface models may have a reduced dimensionality with respect to the initial subsurface model, resulting in a compressed model space that requires less exhaustive sampling.

In an alternative embodiment, the initial subface model is perturbed prior to block 104 whereby a plurality of expanded model perturbations are generated at the initial dimensionality and then compressed at block 104 (e.g., via image segmentation at block 105 and/or geometric data compression at block 106) to produce a plurality of compressed model perturbations. In this alternative embodiment, the compressed model perturbations may uncompressed or expanded to the initial dimensionality producing expanded model perturbations. For example, an inverse or adjoint transform may be applied to the compressed model perturbations whereby the dimensionality of the compressed model perturbations is transferred from the compressed dimensionality to the initial dimensionality. In this alternative embodiment, the expanded model perturbations may be combined at block 108 with the initial subsurface model to produce the initial particles. In this manner, the advantages of model compression may be obtained without needing to actually compress the initial subsurface model with only perturbations of the initial subsurface model being subject to compression.

In this exemplary embodiment, method 100 additionally includes block 110, which represents forward modeling, and block 114, which represents the computing system 60 running an efficient particle-based inference algorithm known as Stein Variational Gradient Descent (SVGD). To perform Bayesian optimization (e.g., a Bayesian inversion) with SVGD, probability distributions are represented by sets of particles instead of probability density functions. These particles can be separate realizations of the 1D elastic earth models consisting of P-wave velocity, S-wave velocity and density profiles. In SVGD, various kernels (e.g., scalar-valued kernels or more general matrix-valued kernels) can be tested for best performance.

In this exemplary embodiment, prior to the execution of block 110, the initial particles are uncompressed or expanded to the initial dimensionality. For example, an inverse or adjoint transform may be applied to the initial particles whereby the dimensionality of the initial particles is transferred from the compressed dimensionality to the initial dimensionality. With the initial particles now at the initial dimensionality, method 100 may proceed to block 110.

Block 110 includes forward modeling that is performed to generate synthetic seismograms for each particle. That is, block 110 includes receipt of a set of particles from block 108. In this exemplary embodiment, the computing system 60, in conjunction with block 110, performs finite difference modeling (e.g., full 3D finite difference modeling) to generate the desired synthetic seismic data as an output in block 112. In other embodiments, forms of forward modeling other than finite difference modeling may be employed at block 110. Thus, block 110 operates to generate synthetic seismic data based upon the initial particles described above and received from block 116, i.e., to generate synthetic seismic data based upon different combinations of Vp, Vs, and density. In this manner, synthetic seismic data is generated in block 112 based on the process undertaken in block 100. This synthetic seismic data is provided to block 114. Additionally, observed seismic data is be provided to block 114 as part of block 114.

In this exemplary embodiment, as part of block 114, at each iteration, prior probabilities are combined with the likelihoods of each particle to form the target density and its gradient is weighted by a kernel function to provide the update directions for each particle. This process is then repeated until it arrives at a final set of particles that closely approximates the posterior distribution. The likelihood is computed assuming a statistical model of the seismic noise. The gradient of likelihood is combined with that of the prior to form gradient scores evaluated at each particle, where the gradient scores are then scaled by a kernel function. The computed gradients are then used to update all the particles simultaneously in each iteration. After a predetermined number of iterations and/or when a pre-determined convergence criterion is met, a final set of particles that represents the target (posterior) distribution is generated. As discussed below, blocks 116, 118, and 120 can be processes undertaken as part of block 114.

In this exemplary embodiment, block 116 of method 100 includes evaluation of the kernel function that is used to scale the above described gradient scores. At block 118 of method 100, the gradient of likelihood is combined with that of the compressed subsurface model from block 108 to form gradient scores evaluated at each particle, where the gradient scores are then scaled by the kernel function from block 116. The kernel function is a mathematical measure of similarity between the particles, but in the context of the algorithm it enforces diversity in the posterior. The computed gradients of block 118 are then used to update all the particles simultaneously in each iteration at block 120 of method 100.

At block 122 of method 100, a determination on whether convergence has occurred is undertaken. This determination may include a predetermined number of iterations of the above described process being undertaken and/or determination of whether a pre-determined convergence criterion is met. If the determination is negative with respect to the convergence in block 122, block 110 is undertaken with the revised values for the particles. If instead, at block 122, convergence is determined to have occurred, the final set of particles that represents the target (posterior) distribution is generated at block 122.

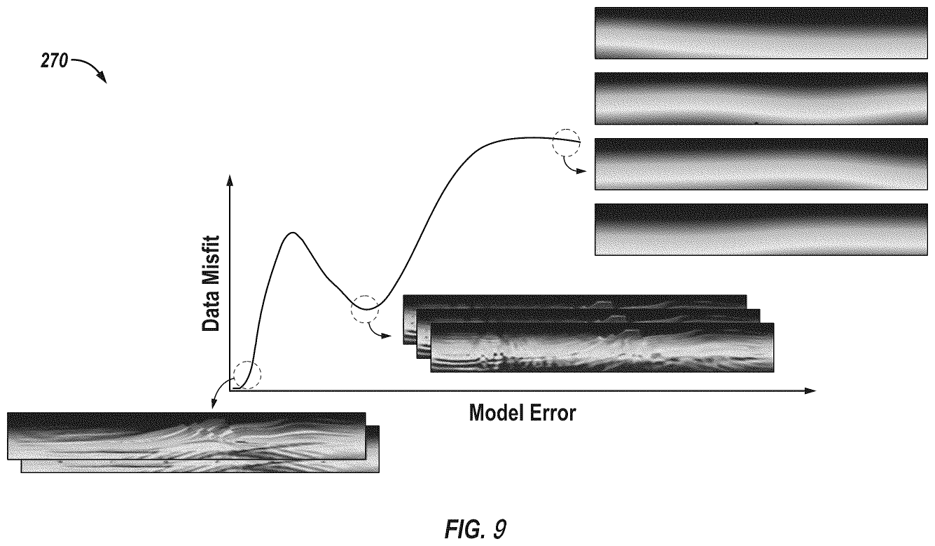

FIG. 9 is a schematic illustration of an exemplary posterior distribution 270 of inverted models (e.g., the particles or models forming the posterior distribution 124 of method 100 comprise inverted models in at least some embodiments) that adequately samples the prior distribution. Particularly, the posterior distribution 270 shown in FIG. 9 are plotted schematically as a function of data misfit (Y-axis of FIG. 9) and model error (X-axis of FIG. 9). FIG. 9 thus illustrates how some inverted models of the posterior distribution 270 carry substantial data misfit and model error (e.g., inverted models 272), while other inverted models of the posterior distribution 270 remain stock at a suboptimal answer or local minimum (e.g., inverted models 274), and still other inverted models of the posterior distribution converge closer to the true answer (e.g., inverted models 276).

The above described technique to carry out Bayesian inversion on raw seismic data in order to estimate seismic velocity and its associated uncertainties provides benefits that include a single workflow for inverting a range of subsurface properties and that provides accurate subsurface predictions for different geological settings. Additionally, the technique provides a means for substantially reducing the dimensionality of the model space to concomitantly reduce the computational costs and complexity of implementing Bayesian inversion. The technique additionally allows for flexibility to select an initial subsurface model appropriate to the end use and that is adaptable to different geological settings (e.g., exploration vs. development, environment, complex or simple geologies). Likewise, the technique requires minimal user interaction and operates without need for interpretation input on items such as horizons, contacts, etc. It should also be noted that the output generated at block 124 of method 100 can, in some embodiments, operate as an additional input to additional lithology and fluid predictions.

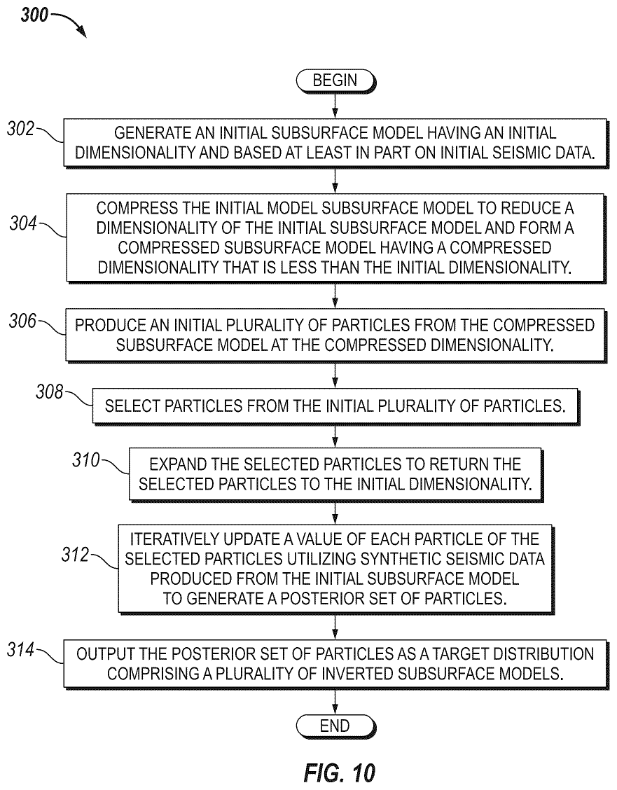

Referring now to FIG. 10, an embodiment of a method 300 for performing stochastic inversion on seismic data to estimate subsurface properties and their associated uncertainties is shown. Beginning at block 302, method 300 comprises generating an initial subsurface model (e.g., initial subsurface model generated at block 102 of method 100 illustrated in FIG. 5, initial subsurface model 200 illustrated in FIG. 6) having an initial dimensionality and based at least in part on initial seismic data.

At block 304, method 300 comprises compressing the initial model subsurface model to reduce a dimensionality of the initial subsurface model and form a compressed subsurface model (e.g., compressed subsurface model generated at block 104 of method 100, compressed subsurface model 220 illustrated in FIG. 8) having a compressed dimensionality that is less than the initial dimensionality. At block 306, method 300 comprises producing an initial plurality of particles (e.g., initial particles of block 108 of method 100) from the compressed subsurface model at the compressed dimensionality.

At block 308, method 300 comprises selecting particles from the initial plurality of particles. At block 310, method 300 comprises expanding the selected particles to return the selected particles to the initial dimensionality. At block 312, method 300 comprises iteratively updating (e.g., the iterative updating performed at block 114 of method 100) a value of each particle of the selected particles utilizing synthetic seismic data (e.g., synthetic seismic data produced at block 112 of method 100) produced from the initial subsurface model to generate a posterior set of particles (e.g., the posterior particles generated at block 124 of method 100). At block 314, method 300 comprises outputting the posterior set of particles as a target distribution comprising a plurality of inverted subsurface models.

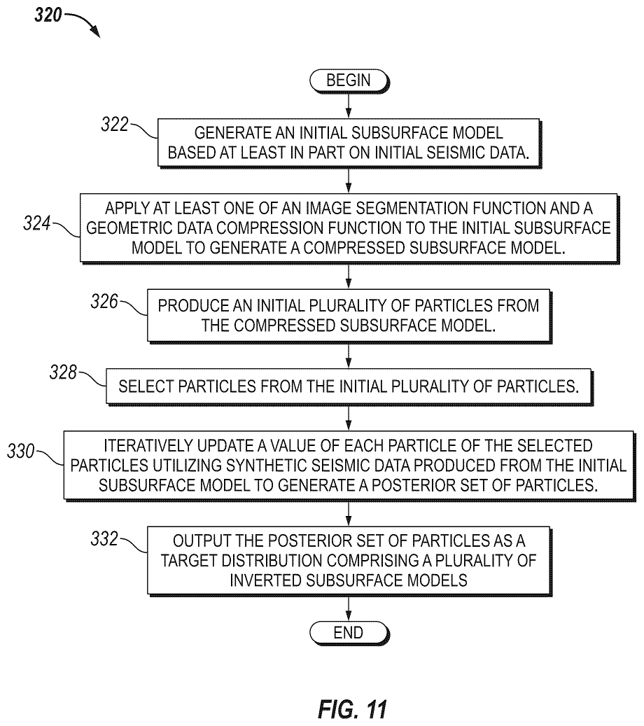

Referring now to FIG. 11, another embodiment of a method 320 for performing stochastic inversion on seismic data to estimate subsurface properties and their associated uncertainties is shown. Beginning at block 322, method 320 comprises generating an initial subsurface model (e.g., initial subsurface model generated at block 102 of method 100 illustrated in FIG. 5, initial subsurface model 200 illustrated in FIG. 6) based at least in part on initial seismic data.

At block 324, method 320 comprises applying at least one of an image segmentation function (e.g., the image segmentation function applied at block 105 of method 100) and a geometric data compression function (e.g., the geometric data compression function applied at block 106 of method 100) to the initial subsurface model to generate a compressed subsurface model (e.g., compressed subsurface model generated at block 104 of method 100, compressed subsurface model 220 illustrated in FIG. 8). At block 326, method 320 comprises producing an initial plurality of particles (e.g., initial particles of block 108 of method 100) from the compressed subsurface model. At block 328, method 320 comprises selecting particles from the initial plurality of particles.

At block 330, method 320 comprises iteratively updating (e.g., the iterative updating performed at block 114 of method 100) a value of each particle of the selected particles utilizing synthetic seismic data (e.g., synthetic seismic data produced at block 112 of method 100) produced from the initial subsurface model to generate a posterior set of particles (e.g., the posterior particles generated at block 124 of method 100). At block 332, method 330 comprises outputting the posterior set of particles as a target distribution comprising a plurality of inverted subsurface models.

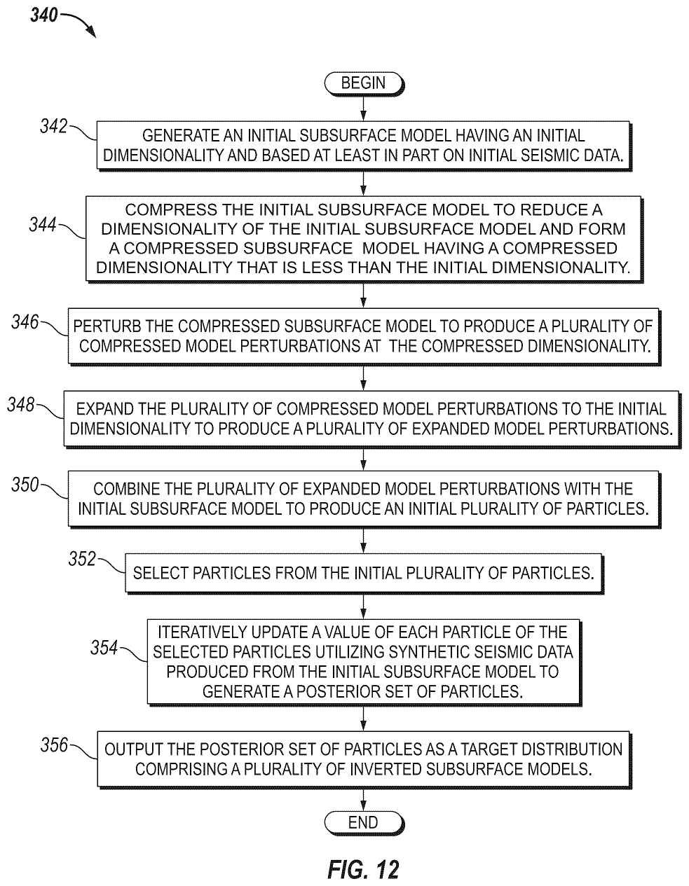

Referring now to FIG. 12, an embodiment of a method 340 for performing stochastic inversion on seismic data to estimate subsurface properties and their associated uncertainties is shown. Beginning at block 342, method 340 comprises generating an initial subsurface model (e.g., initial subsurface model generated at block 102 of method 100 illustrated in FIG. 5, initial subsurface model 200 illustrated in FIG. 6) having an initial dimensionality and based at least in part on initial seismic data.

At block 344, method 340 comprises compressing the initial subsurface model to reduce a dimensionality of the initial subsurface model and form a compressed subsurface model (e.g., compressed subsurface model generated at block 104 of method 100, compressed subsurface model 220 illustrated in FIG. 8) having a compressed dimensionality that is less than the initial dimensionality. At block 346, method 340 comprises perturbing the compressed subsurface model to produce a plurality of compressed model perturbations at the compressed dimensionality. At block 348, method 340 comprises expanding the plurality of compressed model perturbations to the initial dimensionality to produce a plurality of expanded model perturbations.

At block 350, method 340 comprises combining the plurality of expanded model perturbations with the initial subsurface model to produce an initial plurality of particles (e.g., initial particles of block 108 of method 100). At block 352, method 350 comprises selecting particles from the initial plurality of particles. At block 354, method 350 comprises iteratively updating (e.g., the iterative updating performed at block 114 of method 100) a value of each particle of the selected particles utilizing synthetic seismic data (e.g., synthetic seismic data produced at block 112 of method 100) produced from the initial subsurface model to generate a posterior set of particles e.g., the posterior particles generated at block 124 of method 100). At block 356, method 340 comprises outputting the posterior set of particles as a target distribution comprising a plurality of inverted subsurface models.

While embodiments of the disclosure have been shown and described, modifications thereof can be made by one skilled in the art without departing from the scope or teachings herein. The embodiments described herein are exemplary only and are not limiting. Many variations and modifications of the systems, apparatus, and processes described herein are possible and are within the scope of the disclosure. For example, the relative dimensions of various parts, the materials from which the various parts are made, and other parameters can be varied. Accordingly, the scope of protection is not limited to the embodiments described herein, but is only limited by the claims that follow, the scope of which shall include all equivalents of the subject matter of the claims. Unless expressly stated otherwise, the steps in a method claim may be performed in any order. The recitation of identifiers such as (a), (b), (c) or (1), (2), (3) before steps in a method claim are not intended to and do not specify a particular order to the steps, but rather are used to simplify subsequent reference to such steps.

What is claimed is:

1. A method for performing stochastic inversion on seismic data to estimate subsurface properties and their associated uncertainties, the method comprising:
(a) generating an initial subsurface model having an initial dimensionality and based at least in part on initial seismic data;
(b) compressing the initial model subsurface model to reduce a dimensionality of the initial subsurface model and form a compressed subsurface model having a compressed dimensionality that is less than the initial dimensionality;
(c) producing an initial plurality of particles from the compressed subsurface model at the compressed dimensionality;
(d) selecting particles from the initial plurality of particles;
(e) expanding the selected particles to return the selected particles to the initial dimensionality;
(f) iteratively updating a value of each particle of the selected particles utilizing synthetic seismic data produced from the initial subsurface model to generate a posterior set of particles; and
(g) outputting the posterior set of particles as a target distribution comprising a plurality of inverted subsurface models.

2. The method of claim 1, wherein the plurality of inverted subsurface models comprises full waveform inversion (FWI) models.

3. The method of claim 1, wherein (b) comprises applying an image segmentation function to the initial subsurface model to generate a segmented subsurface model defined by a lesser amount of data than the initial subsurface model.

4. The method of claim 1, wherein (b) comprises applying a K-means image segmentation function to the initial subsurface model whereby pixels of the initial subsurface model are grouped into separate clusters.

5. The method of claim 1, wherein (b) comprises applying a data compression function to the initial subsurface model to generate the compressed subsurface model defined by a lesser amount of data than the initial subsurface model.

6. The method of claim 1, wherein (b) comprises applying a data compression function to the initial subsurface model whereby at least some of a plurality of geometric features of the initial subsurface model are approximated by compressed geometric features having predefined geometric elements.

7. The method of claim 6, wherein the compressed geometric features comprise B-spline curves and the geometric elements comprise one or more control points and one or more knot vectors.

8. The method of claim 1, wherein (b) comprises:
(b1) applying an image segmentation function to the initial subsurface model to generate a segmented subsurface model defined by a lesser amount of data than the initial subsurface model; and
(b2) applying a data compression function to the segmented subsurface model to generate the compressed subsurface model defined by a lesser amount of data than the segmented subsurface model.

9. A method for performing stochastic inversion on seismic data to estimate subsurface properties and their associated uncertainties, the method comprising:
(a) generating an initial subsurface model based at least in part on initial seismic data;
(b) applying at least one of an image segmentation function and a geometric data compression function to the initial subsurface model to generate a compressed subsurface model;
(c) producing an initial plurality of particles from the compressed subsurface model;
(d) selecting particles from the initial plurality of particles;
(e) iteratively updating a value of each particle of the selected particles utilizing synthetic seismic data produced from the initial subsurface model to generate a posterior set of particles; and
(f) outputting the posterior set of particles as a target distribution comprising a plurality of inverted subsurface models.

10. The method of claim 9, wherein the plurality of inverted subsurface models comprises full waveform inversion (FWI) models.

11. The method of claim 9, wherein (b) comprises applying the image segmentation function to the initial subsurface model to generate a segmented subsurface model having a reduced dimensionality with respect to a dimensionality of the initial subsurface model.

12. The method of claim 9, wherein (b) comprises applying the data compression function to the initial subsurface model to generate the compressed subsurface model having a reduced dimensionality with respect to the initial subsurface model.

13. The method of claim 9, wherein (b) comprises:
(b1) applying the image segmentation function to the initial subsurface model to generate a segmented subsurface model defined by a lesser amount of data than the initial subsurface model; and
(b2) applying the data compression function to the segmented subsurface model to generate the compressed subsurface model defined by a lesser amount of data than the segmented subsurface model.

14. A method for performing stochastic inversion on seismic data to estimate subsurface properties and their associated uncertainties, the method comprising:
(a) generating an initial subsurface model having an initial dimensionality and based at least in part on initial seismic data;
(b) compressing the initial subsurface model to reduce a dimensionality of the initial subsurface model and form a compressed subsurface model having a compressed dimensionality that is less than the initial dimensionality;
(c) perturbing the compressed subsurface model to produce a plurality of compressed model perturbations at the compressed dimensionality;
(d) expanding the plurality of compressed model perturbations to the initial dimensionality to produce a plurality of expanded model perturbations;
(e) combining the plurality of expanded model perturbations with the initial subsurface model to produce an initial plurality of particles;
(f) selecting particles from the initial plurality of particles;
(g) iteratively updating a value of each particle of the selected particles utilizing synthetic seismic data produced from the initial subsurface model to generate a posterior set of particles; and
(h) outputting the posterior set of particles as a target distribution comprising a plurality of inverted subsurface models.

15. The method of claim 14, wherein the plurality of inverted subsurface models comprises full waveform inversion (FWI) models.

16. The method of claim 14, wherein (b) comprises applying an image segmentation function to the initial subsurface model to generate a segmented subsurface model defined by a lesser amount of data than the initial subsurface model.

17. The method of claim 14, wherein (b) comprises applying a K-means image segmentation function to the initial subsurface model whereby pixels of the initial subsurface model are grouped into separate clusters.

18. The method of claim 14, wherein (b) comprises applying a data compression function to the initial subsurface model to generate the compressed subsurface model defined by a lesser amount of data than the initial subsurface model.

19. The method of claim 14, wherein (b) comprises applying a data compression function to the initial subsurface model whereby at least some of a plurality of geometric features of the initial subsurface model are approximated by compressed geometric features having predefined geometric elements.

20. The method of claim 19, wherein the compressed geometric features comprise B-spline curves and the geometric elements comprise one or more control points and one or more knot vectors.
